(19) United States
(12) Patent Application Publication
(10) Pub. No.: US 2010/0065734 A1
(43) Pub. Date: Mar. 18, 2010

(54) PARTICLE SORTING APPARATUS AND METHOD

(75) Inventor: Robert David Morrison, Brookfield Queensland (AU)

Correspondence Address: OSHA LIANG L.L.P., TWO HOUSTON CENTER, 909 FANNIN, SUITE 3500, HOUSTON, TX, 77010, US

(73) Assignee: THE UNIVERSITY OF QUEENSLAND, St. Lucia Qld (AU)

(21) Appl. No.: 12/517,663

(22) PCT Filed: Nov. 30, 2007
(86) PCT No.: PCT/AU2007/001856

§ 371 Date: Aug. 10, 2009

(30) Foreign Application Priority Data
Dec. 4, 2006 (AU) 2006906757
May 2, 2007 (AU) 2007902305

(51) Int. Cl. B07C 5/344; H01J 49/28

(52) U.S. Cl. 250/282; 250/294

(57) ABSTRACT

A particle sorting apparatus for sorting particles following a free flight trajectory including: a detector for detecting a characteristic of the particles before or after they enter the free flight trajectory; an ionization source that emits a stream of ions for selectively applying charge to particles following the free flight trajectory; a static electric field for deflecting particles that have been charged by the ionization source; and means for deflecting the stream of ions emitted from the ionization source between a first orientation in which the stream of ions does not intersect the free flight trajectory and a second orientation in which the stream of ions does intersect the free flight trajectory depending on whether a particle following the free flight trajectory is detected as having the characteristic or not.

### FIELD OF THE INVENTION

The present invention relates to a particle sorting apparatus and method. In particular, the invention relates to a particle sorting apparatus and method that involves analysing particles to detect the presence or absence of a particular characteristic, applying a charge to selected particles when they are following a free flight trajectory based on that analysis, and deflecting the charged particles from the free flight trajectory.

### BACKGROUND TO THE INVENTION

Machines for sorting particles of material, for example rock fragments, are known. In many instances, particles to be sorted are projected into free flight trajectory and selected particles are deflected by blasts of fluid, generally air blasts, by the operation of electrically controlled blast valves. The deflected particles are separated from the particles that are not deflected by a fixed splitter plate located downstream from the blast zone. The particles are usually projected in a narrow band of adjacent streams each presenting particles one by one to a detector and the fluid blast zone.

These existing machines have severe limitations when it is necessary to treat large numbers of particles on a one-to-one basis down to a small particle size. In some plants, the material to be sorted is upgraded by feeding low tonnages per unit time to each of several machines, blasting a comparatively large number of undesirable particles for each desirable particle, and repeating this process by reporting the accepted material a sufficient number of times to eventually produce an acceptable product grade.

To increase plant capacity with conventional equipment, several banks of machines treating identical feed in parallel may be required, but if each machine incorporates expensive feed and detection equipment, it is important to minimise the number used for a given task.

It has also been proposed to separate particulate material electrically. According to this proposal all particles passing through an electrical charging field are charged according to their electrical surface conductivity. The success of such separation is dependent on sufficient differential electrical surface conductivity of the particulate material to be separated. Thus, charge applied to particles passing through the electric field is more mobile on more conductive material and therefore able to discharge more fully onto a counter electrode brought into contact with a portion of the particle surface. However, such differential surface effects are extremely prone to masking by, for example, moisture or other surface contamination, and it is often the case that significant proportions of waste have similar electrical conduction properties to the particulate material to be separated. As such separation by this method may not be successful in some cases.

The problem of sorting desired particles from undesired particles whilst diluting the accepted product with as few undesirable species as possible, and at the same time taking care not to leave any desired particles uncollected, becomes an increasingly difficult task as the size of the particles is decreased and the number of such particles per unit time is increased.

The present invention aims to provide an alternative particle sorting apparatus and method that addresses and/or alleviates at least some of these issues.

### SUMMARY OF THE INVENTION

According to one aspect of the invention there is provided a particle sorting apparatus for sorting particles following a free flight trajectory including:

a detector for detecting a characteristic of the particles before or after they enter the free flight trajectory;

an ionization source that emits a stream of ions for selectively applying charge to particles following the free flight trajectory;

a static electric field for deflecting particles that have been charged by the ionization source; and

means for deflecting the stream of ions emitted from the ionization source between a first orientation in which the stream of ions does not intersect the free flight trajectory and a second orientation in which the stream of ions does intersect the free flight trajectory depending on whether a particle following the free flight trajectory is detected as having the characteristic or not.

The means for deflecting the stream of ions, for example a corona beam, may take any suitable form. In a preferred embodiment, however, the means for deflecting the stream of ions includes at least two static electrodes. An optional focussing electrode may also be included. Preferably, the voltage applied to the static electrodes can be varied rapidly in response to a signal from the detector. More particularly, it is preferred that the application of a high voltage to a first of the static electrodes and a low voltage to a second of the static electrodes directs the stream of ions to an earthed bypass electrode, corresponding to the first orientation of the stream of ions, and application of a lower voltage to the first of the static electrodes and a higher voltage to the second of the static electrodes results in deflection of the stream of ions away from the earthed bypass electrode and into the free flight trajectory, corresponding to the second orientation of the stream of ions.

Where the means for deflecting the stream of ions includes at least two static electrodes, as described in the immediately preceding paragraph, the static electrodes are preferably positioned remote from the free flight trajectory so as to avoid particle contact.

The characteristic detected by the detector, and therefore the type of detector included in the apparatus, is not particularly limited. This may detect any desirable or undesirable characteristic of the particles being sorted. In certain embodiments, the detector detects one or more of the selective emission or reflection of electromagnetic irradiation, the ability to attenuate the passage of electromagnetic irradiation, different electrical conductivity, different magnetic susceptibility and particle size.

The ionization source may also take any suitable form. Preferably the ionization source includes a fine wire or braided wire corona source operated at high voltage.

In order to facilitate optimal deflection of the charged particles from the free flight trajectory, the static electric field is preferably orientated transverse to the free flight trajectory. It will be appreciated that the electric field may be orientated at an angle to the free flight trajectory if necessary without departing from the spirit of the invention.

The static field will typically be provided between two electrodes. A vertical electrode below the level of the stream of ions and on the ionization source side of the particle trajectories is preferably supplied with a constant high voltage of the same polarity as, for example, the corona. This electrode may be provided with an insulating cover as is common practice, for example, in electrostatic precipitators.

An inclined electrode is preferably provided as the second electrode forming the static field and is inclined away from the free flight trajectory on the opposite side from the ionization source. This electrode can be grounded for simple separations or fine particles or supplied with a constant high voltage of polarity opposite to the ionization source for difficult separations. In the latter case, this electrode may also be provided with an insulating cover.

Further to the above, the static electric field may extend over any desirable distance. This will to a large extent be dependent on the size of the particles being sorted. Preferably, the static electric field extends over a distance of from 0.1 m to 3 m. For example, for some particles of less than 1 mm in size, an electric field of about a few hundred millimetres will generally suffice. For larger particles, for example in the order of up to 30 mm, an electric field extending over a distance of from 2 m to 3 m will generally be adequate to generate sufficient displacement of the particles.

In some instances it will be desirable to sort particles into different grades, for example different grades of ore. As such, according to one embodiment the detector provides a measure of particle composition and particle size and the means for deflecting the corona beam is operable to provide a pre-selected amount of charge to a particle resulting in a predetermined charge to mass ratio that corresponds to a grade of the particle. Generally, the means for deflecting the corona beam is operable to ensure the charge is applied to any given particle for a predetermined period of time, thus resulting in a particular charge being applied to each particle. In this case, particles having a different charge to mass ratio may be deflected by the static electric field to differing degrees, thereby facilitating collection of separate grades of particle by means of suitably placed splitters.

If the particles are susceptible to contact electrification, the particle sorting apparatus may include a low intensity corona of alternating polarity or an earthed conductive plate to neutralise any charge on the particles before they enter the free flight trajectory. In some cases, however, selective contact charging may be helpful and these measures will not be required.

As was the case with the prior art described above, in some instances it may be desirable to feed a number of streams of particles into the apparatus at one time, thereby improving throughput. As such, in some embodiments the particle sorting apparatus includes a plurality of channels through which particles are conveyed and which correspond with separate free flight trajectories, each channel including a pair of static electrodes defining means for deflecting a respective stream of ions associated with a respective channel. In this case, the apparatus preferably also includes spaced charge isolating electrodes fitted to opposing sides of each channel.

In an alternative embodiment, it may be desirable to separate a stream or bed of generally smaller particles travelling through the free flight trajectory as a curtain of particles, rather than in discrete channels. In that case, the apparatus is adapted to convey particles to the free flight trajectory as a bed to form a curtain of particles in free flight. According to this embodiment, preferably a first array and a second array of static electrodes are provided defining a plurality of pairs of static electrodes. Preferably, each static electrode of the first array and second array is associated with separation electrodes located adjacent opposing sides thereof. Any separation electrodes contained within each of the first and second arrays that are adjacent to one another are generally divided by an insulator.

According to this embodiment, the previously described spaced, charge isolating electrodes are replaced with separation electrodes that are divided by insulators. Increasing the voltage on one separation electrode located on one side of an associated static electrode while decreasing the voltage on another separation electrode on the opposing side of the static electrode can advantageously swing the beam of ions towards the lower voltage separation electrode of the pair.

In certain embodiments, for example where large particles of very low conductivity are being sorted, the charge may not be adequately distributed around the particles by conduction. In such cases, it may be desirable to include a duplicate arrangement to that described above on an opposing side of the free flight trajectory. This may advantageously result in a required charge to mass ratio for the particles. As such, according to another embodiment of the invention, the apparatus includes a second ionization source that emits a stream of ions for selectively applying charge to particles following the free flight trajectory, and means for deflecting the stream of ions emitted from the second ionization source between a first orientation in which the stream of ions does not intersect the free flight trajectory and a second orientation in which the stream of ions does intersect the free flight trajectory depending on whether a particle following the free flight trajectory is detected as having the characteristic or not.

According to another aspect of the invention there is provided a method of sorting particles following a free flight trajectory based on a characteristic of the particles including:

analysing the particles to detect the presence or absence of the characteristic;

selectively applying a charge to the particles depending on the presence or absence of the characteristic; and

passing the particles through a static electric field thereby deflecting particles to which a charge has been applied from the free flight trajectory;

wherein charge is selectively applied to the particles by deflecting a stream of ions emitted from an ionization source between a first orientation in which the stream of ions does not intersect the free flight trajectory of the particles and a second orientation in which the stream of ions does intersect the free flight trajectory of the particles.

Preferred embodiments of the method of the invention may be gleaned from the above description of the apparatus according to the invention. Nevertheless, the following comments are made in relation to the method.

The particles may again be analysed to detect the presence or absence of any desirable or undesirable characteristic. For example, the particles may be analysed to detect one or more of the selective emission or reflection of electromagnetic irradiation, the ability to attenuate the passage of electromagnetic irradiation, different electrical conductivity, different magnetic susceptibility and particle size.

Deflection of the stream of ions may be achieved by any suitable means. Preferably the source of ions is deflected by applying predetermined voltages to at least two static electrodes positioned relative to the stream of ions. The stream of ions may again include a corona beam.

In certain embodiments the analysis of the particles provides a measure of particle composition and particle size and charge is selectively applied to the particles to provide a pre-selected amount of charge to a particle resulting in a predetermined charge to mass ratio corresponding to a grade of the particle.

It may also be desirable in certain embodiments to neutralise any charge on the particles before or as they enter the free flight trajectory.

### DETAILED DESCRIPTION OF THE INVENTION

A more detailed description of the invention will now be described with reference to the accompanying drawings. It should be appreciated that the detailed description of the invention is provided for illustrative purposes only and this should not be construed as limiting on the invention in any way. Referring to the drawings:

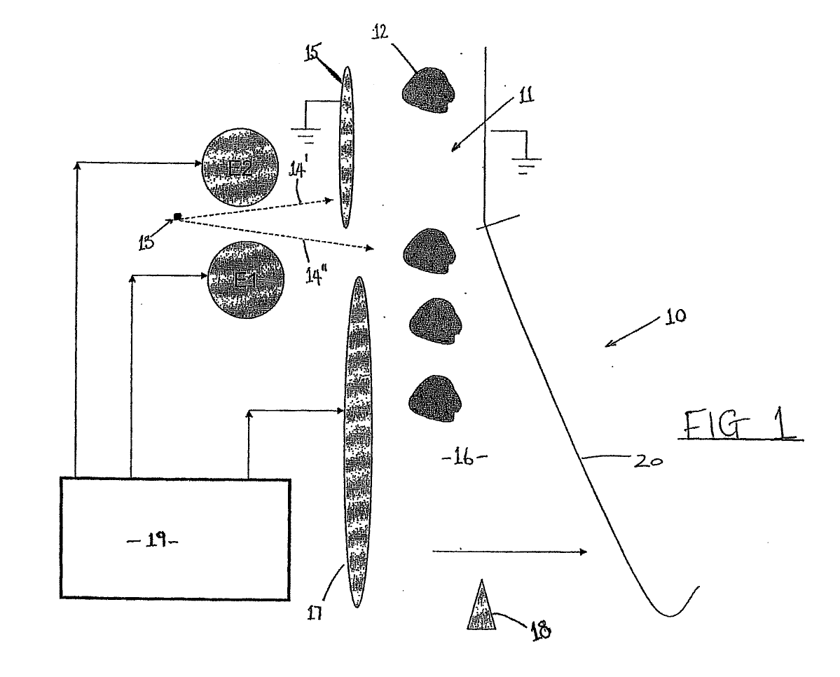

FIG. 1 illustrates a simplified schematic of a sorting apparatus in accordance with an embodiment of the invention; and

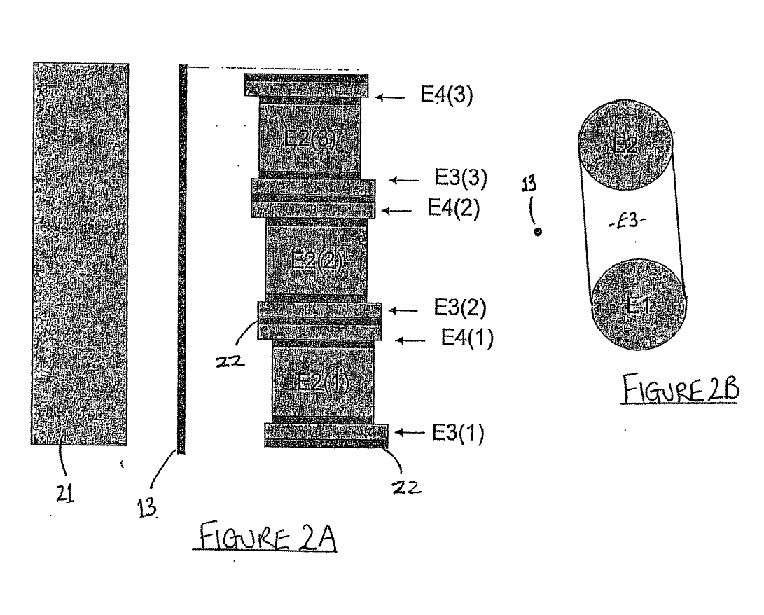

FIGS. 2A and 2B respectively illustrate a simplified partial schematic and of a sorting apparatus and a side view of that apparatus, in accordance with an alternative embodiment of the invention.

Referring to FIG. 1, a sorting apparatus 10 includes a free flight trajectory 11 through which particles 12 are passed. A corona wire 13 acts as a source of ionization and produces a corona beam 14. The beam may be focussed more tightly by the addition of static electrode 21 which would typically be supplied with the same voltage as the corona source. The corona beam is operable between a first orientation 14′ and a second orientation 14″. In the first orientation 14′ a high voltage is applied to a first static electrode E1 and a low voltage applied to a second static electrode E2. This causes the corona beam 14 to be directed towards an earthed bypass electrode 15. In the second orientation 14″ a lower voltage is applied to the first static electrode E1 and a higher voltage applied to the second static electrode E2. This deflects the corona beam 14 to the second orientation 14″ in which it intersects the free flight trajectory 11 of the particles 12. For selected particles, the corona beam may momentarily track the movement of the particle to maximise the electrical charge on the particle.

As such, depending on whether a particular characteristic is detected or not by a detector (not shown), voltage can be varied rapidly between the two static electrodes E1 and E2 to move the corona beam 14 from the first orientation 14′ to the second orientation 14″ and vice versa. This results in selective charging of the particles 12 as they follow the free flight trajectory 11.

A static electric field 16 is produced between electrodes 17 and 20, the electric field 16 being in the free flight trajectory 11 of the particles 12. As particles that have been selectively charged travel through the electric field 16, they are deflected away from the electrode 17. Generally, particles with no charge will travel directly downward while particles with increasing charge to mass ratio will be deflected to an increasing extent away from the electrode 17. Thus, uncharged particles and charged particles are sorted on either side of a splitter 18.

Generally, the apparatus will be managed using a computer controlled high tension power supply 19 that supplies power to the static electrodes E1 and E2 and to the electrode 17. This advantageously facilitates rapid and accurate response and control of the apparatus.

The voltages to be applied will depend on the electrode configuration, spacing and the surface to mass ratio of the particles to be sorted. However, the following paragraphs provide some illustrative values. It will be appreciated that the invention is not necessarily limited to these values.

For a spacing of 50 mm from a corona or ionising electrode 13 (with an effective electrode diameter of 0.2 mm) to the bypass electrode 15, the corona voltage is advantageously in the range of 15 to 25 kV.

A voltage of about 15 kV at an ionising current of about 0.2 mA/m will be suitable for fine particles with a high surface to mass ratio. Larger particles with much lower surface to mass ratios will require the highest possible ionising current before spark over occurs. Maximum currents are preferably in the range of about 1.5 to 2 mA/m with the potential to achieve up to about 40 mA/m2 at the centre of the beam for very rapid charging of the target particle.

Static electrodes E1 and E2 will preferably operate at about 5 kV lower than the ionising electrode in bypass mode. To swing the beam, the repelling electrode E2 will be raised rapidly towards the ionising voltage and electrode E1 will be lowered by up to 5 kV. To maximise the swing rate, a voltage of the same polarity as the corona may be briefly applied to the bypass electrode. Depending on the combined electrode geometry, it may optionally be advantageous to increase the ionising voltage for a brief period while the effective electrode spacing is increased. This strategy would be appropriate for a sorter with separate channels.

Referring to FIGS. 2A and 2B, a first array of static electrodes E1 and a second array of static electrodes E2 are provided. Again, a corona wire 13 is provided that acts as a source of a corona beam that may be deflected as previously described. In this embodiment, separation electrodes E3 and E4 are provided on either side of each of the static electrodes E2(1), E2(2), etc, in the first array E1 and second array E2. Insulators 22 are located between adjacent separation electrodes E3, E4.

Increasing the voltage on one of the separation electrodes E3, E4 while decreasing the voltage on the other of the separation electrodes E3, E4 will swing the corona beam towards the lowered voltage edge of the respective channel defined by the pair of static electrodes E1 and E2.

If desired, a further static electrode 21 may be provided on an opposing side of the corona wire 13. The remainder of the apparatus is as described previously.

It is envisaged that this embodiment of the invention may be particularly suitable when removal of a small portion of the feed material is required, for example when the feed material is supplied as a curtain of particles through the free flight trajectory. Smaller particles may also be more suitably processed using this embodiment.

To facilitate sideways control of the beam of ions, a similar strategy to the one used to control electrodes E1 and E2 may be applied to each pair of electrodes E3 and E4

It will be appreciated that the foregoing description is has been given by way of illustrative example of the invention and that all such modifications and variations thereto as would be apparent to persons of skill in the art are deemed to fall within the broad scope and ambit of the invention as herein set forth.

1. A particle sorting apparatus for sorting particles following a free flight trajectory including:
a detector for detecting a characteristic of the particles before or after they enter the free flight trajectory;
an ionization source that emits a stream of ions for selectively applying charge to particles following the free flight trajectory;
a static electric field for deflecting particles that have been charged by the ionization source; and
means for deflecting the stream of ions emitted from the ionization source between a first orientation in which the stream of ions does not intersect the free flight trajectory and a second orientation in which the stream of ions does intersect the free flight trajectory depending on whether a particle following the free flight trajectory is detected as having the characteristic or not.

2. A particle sorting apparatus according to claim 1, wherein the means for deflecting the stream of ions includes at least two static electrodes

3. A particle sorting apparatus according to claim 2, wherein the voltage applied to the static electrodes can be varied rapidly in response to a signal from the detector.

4. A particle sorting apparatus according to claim 3, wherein application of a high voltage to a first of the static electrodes and a low voltage to a second of the static electrodes directs the stream of ions to an earthed bypass electrode, corresponding to the first orientation of the stream of ions, and application of a low voltage to the first of the static electrodes and a high voltage to the second of the static electrodes results in deflection of the stream of ions away from the earthed bypass electrode and into the free flight trajectory, corresponding to the second orientation of the stream of ions.

5. A particle sorting apparatus according to claim 2, wherein the static electrodes are positioned remote from the free flight trajectory so as to avoid particle contact

6. A particle sorting apparatus according to claim 1, wherein the detector detects one or more of the selective emission or reflection of electromagnetic irradiation, the ability to attenuate the passage of electromagnetic irradiation, different electrical conductivity, different magnetic susceptibility and particle size.

7. A particle sorting apparatus according to claim 1, wherein the ionization source includes a fine wire or braided wire corona source operated at high voltage.

8. A particle sorting apparatus according to claim 1, wherein the static electric field is transverse to the free flight trajectory.

9. A particle sorting apparatus according to claim 8, wherein the static electric field extends over a distance of from 0.1 m to 3 m.

10. A particle sorting apparatus according to claim 1, wherein the detector provides a measure of particle composition and particle size and the means for deflecting the corona beam is operable to provide a pre-selected amount of charge to a particle resulting in a predetermined charge to mass ratio that corresponds to a grade of the particle.

11. A particle sorting apparatus according to claim 1, including a vertical electrode positioned on the same side of the free flight trajectory to that of the ionization source, the vertical electrode being supplied with a high potential of similar polarity to the ionization source.

12. A particle sorting apparatus according to claim 11, wherein the vertical electrode is provided with an insulating cover.

13. A particle sorting apparatus according to claim 11, including an inclined electrode on the opposite side of the free flight trajectory to that of the ionization source, the inclined electrode being earthed or of opposite polarity to the ionization source.

14. A particle sorting apparatus according to claim 13, wherein the inclined electrode is provided with an insulating cover.

15. A particle sorting apparatus according to claim 1, including a low intensity corona of alternating polarity or an earthed conductive plate to neutralise any charge on the particles before they enter the free flight trajectory.

16. A particle sorting apparatus according to claim 2, including a plurality of channels through which particles are conveyed and which correspond with separate free flight trajectories, each channel including a pair of static electrodes defining means for deflecting a respective stream of ions associated with a respective channel.

17. A particle sorting apparatus according to claim 16, including space charge isolating electrodes fitted to opposing sides of each channel.

18. A particle sorting apparatus according to claim 2, the apparatus being adapted to convey particles to the free flight trajectory as a bed to form a curtain of particles in free flight.

19. A particle sorting apparatus according to claim 18, wherein a first array and a second array of static electrodes are provided defining a plurality of pairs of static electrodes.

20. A particle sorting apparatus according to claim 19, wherein each static electrode of the first array and second array is associated with a separation electrode located adjacent opposing sides thereof.

21. A particle sorting apparatus according to claim 20, wherein adjacent separation electrodes are divided by an insulator.

22. A particle sorting apparatus according to claim 1, including a second ionization source that emits a stream of ions for selectively applying charge to particles following the free flight trajectory, and means for deflecting the stream of ions emitted from the second ionization source between a first orientation in which the stream of ions does not intersect the free flight trajectory and a second orientation in which the stream of ions does intersect the free flight trajectory depending on whether a particle following the free flight trajectory is detected as having the characteristic or not.

23. A method of sorting particles following a free flight trajectory based on a characteristic of the particles including:
analysing the particles to detect the presence or absence of the characteristic;
selectively applying a charge to the particles depending on the presence or absence of the characteristic; and
passing the particles through a static electric field thereby deflecting
particles to which a charge has been applied from the free flight trajectory;
wherein charge is selectively applied to the particles by deflecting a stream of ions emitted from an ionization source between a first orientation in which the stream of ions does not intersect the free flight trajectory of the particles and a second orientation in which the stream of ions does intersect the free flight trajectory of the particles.

24. A method according to claim 23, wherein the particles are analysed to detect one or more of the selective emission or reflection of electromagnetic irradiation, the ability to attenuate the passage of electromagnetic irradiation, different electrical conductivity, different magnetic susceptibility and particle size.

25. A method according to claim 23, wherein the stream of ions is deflected by applying predetermined voltages to at least two static electrodes positioned relative to the stream of ions.

26. A method according to claim 23, wherein the analysis of the particles provides a measure of particle composition and particle size and charge is selectively applied to the particles to provide a pre-selected amount of charge to a particle resulting in a predetermined charge to mass ratio corresponding to a grade of the particle.

27. A method according to claim 23, including neutralising any charge on the particles before or as they enter the free flight trajectory.
